(19) United States
(12) Patent Application Publication
(10) Pub. No.: US 2024/0079670 A1
(43) Pub. Date: Mar. 7, 2024

(54) SEALING INTERFACES BETWEEN THERMAL BARRIER ASSEMBLIES AND ADJACENT STRUCTURES WITHIN TRACTION BATTERY PACKS

(71) Applicant: FORD GLOBAL TECHNOLOGIES, LLC, Dearborn, MI (US)

(72) Inventors: Mohammadreza Eftekhari, Novi, MI (US); Kevin Durand Byrd, Novi, MI (US); Kanchana Perumalla, Troy, MI (US)

(21) Appl. No.: 18/176,731

(22) Filed: Mar. 1, 2023

Related U.S. Application Data
(60) Provisional application No. 63/403,445, filed on Sep. 2, 2022.

(51) Int. Cl. H01M 10/625; B60L 50/64; H01M 10/653; H01M 10/6554; H01M 50/211; H01M 50/264; H01M 50/271; H01M 50/367

(52) U.S. Cl. CPC H01M 10/625; B60L 50/64; H01M 10/653; H01M 10/6554; H01M 50/211; H01M 50/264; H01M 50/271; H01M 50/367; H01M 2220/20

(57) ABSTRACT

Thermal barrier assemblies are provided for use within traction battery packs. An exemplary thermal barrier assembly may include features for establishing a sealed interface relative to one or more adjacent structures of a traction battery pack. In some implementations, the thermal barrier assembly may provide features for interfacing with cell stack cross-members beams, upper enclosure structures, lower enclosure structures, etc. The sealed interfaces substantially prevent thermal energy from moving from compartment-to-compartment/cell packet-to-cell packet during a battery thermal event.

### CROSS-REFERENCE TO RELATED APPLICATIONS

This disclosure claims priority to U.S. Provisional Application No. 63/403,445, which was filed on Sep. 2, 2022 and is incorporated herein by reference.

### TECHNICAL FIELD

This disclosure relates generally to thermal barrier assemblies for traction battery packs. An interface between the thermal barrier assembly and at least one adjacent structure may be sealed for blocking the movement of thermal energy from one cell stack compartment to another.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack comprising a first cross-member beam, a battery cell supported by the first cross-member beam, and a thermal barrier assembly connected to the first cross-member beam by a tongue-and-groove connection.

In a further non-limiting embodiment of the foregoing traction battery pack, the battery cell is supported between the first cross-member beam and a second cross-member beam.

In a further non-limiting embodiment of either of the foregoing traction battery packs, a third cross-member beam is adjacent to the first cross-member beam. The first cross-member beam and the third cross-member beam establish a cross-member assembly arranged between the cell stack and a second cell stack of the traction battery pack.

In a further non-limiting embodiment of any of the foregoing traction battery packs, a venting passageway is disposed between the first cross-member beam and the third cross-member beam.

In a further non-limiting embodiment of any of the foregoing traction battery packs, the thermal barrier assembly provides a male portion of the tongue-and-groove connection, and the first cross-member beam provides a female portion of the tongue-and-groove connection.

In a further non-limiting embodiment of any of the foregoing traction battery packs, the male portion includes a protrusion that is part of a fin of the thermal barrier assembly.

In a further non-limiting embodiment of any of the foregoing traction battery packs, the female portion includes a groove formed at an end-facing surface of the first cross-member beam. The end-facing surface faces in a direction toward a compression plate of the cell stack.

In a further non-limiting embodiment of any of the foregoing traction battery packs, the female portion includes a groove formed at an inside-facing surface of the first cross-member beam. The inside-facing surface faces in a direction toward a second cross-member beam of the cell stack.

In a further non-limiting embodiment of any of the foregoing traction battery packs, an adhesive is disposed between the male portion and the female portion.

In a further non-limiting embodiment of any of the foregoing traction battery packs, the thermal barrier assembly includes an upper interfacing structure configured to interface with an upper enclosure structure of the traction battery pack.

In a further non-limiting embodiment of any of the foregoing traction battery packs, the upper interfacing structure includes a basin configured to receive an adhesive.

In a further non-limiting embodiment of any of the foregoing traction battery packs, the thermal barrier assembly includes a lower interfacing structure configured to interface with a heat exchanger plate of the traction battery pack.

In a further non-limiting embodiment of any of the foregoing traction battery packs, the lower interfacing structure includes a seal received within a slot of the heat exchanger plate.

In a further non-limiting embodiment of any of the foregoing traction battery packs, an expandable adhesive is disposed between the heat exchanger plate and an enclosure tray of the traction battery pack.

In a further non-limiting embodiment of any of the foregoing traction battery packs, the thermal barrier assembly includes a side interfacing structure configured to interface with a bus bar of the cell stack.

A traction battery pack according to another exemplary aspect of the present disclosure includes, among other things, an enclosure assembly establishing an interior area, a cell stack housed within the interior area and including a thermal barrier assembly, and a heat exchanger plate arranged between the cell stack and an enclosure tray of the enclosure assembly. The thermal barrier assembly is configured to establish a first sealed interface relative to an upper enclosure structure, a second sealed interface relative to the heat exchanger plate, and a third sealed interface relative to a first cross-member beam of the cell stack.

In a further non-limiting embodiment of the foregoing traction battery pack, the first sealed interface is established by an upper interfacing structure of the thermal barrier assembly and the upper enclosure structure. An adhesive is disposed between the upper interfacing structure and the upper enclosure structure.

In a further non-limiting embodiment of either of the foregoing traction battery packs, the second sealed interface is established by a lower interfacing structure of the thermal barrier assembly and the heat exchanger plate. The lower interfacing structure includes a seal received within a slot of the heat exchanger plate.

In a further non-limiting embodiment of any of the foregoing traction battery packs, the third sealed interface is established by a tongue-and-groove connection provided by the thermal barrier assembly and the first cross-member beam.

In a further non-limiting embodiment of any of the foregoing traction battery packs, the thermal barrier assembly is configured to establish a fourth sealed interface relative to a bus bar that is held within the first cross-member beam.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view through section 3-3 of FIG. 2.

FIG. 4 illustrates an exemplary cell stack of the traction battery pack of FIGS. 2 and 3.

FIG. 5 is a partially exploded view of the cell stack of FIG. 4.

FIG. 6 illustrates an interface between a thermal barrier assembly and a cross-member beam of a battery cell stack of a traction battery pack.

FIG. 7 illustrates another exemplary interface between a thermal barrier assembly and a cross-member beam of a battery cell stack of a traction battery pack.

FIG. 8 illustrates yet another exemplary interface between a thermal barrier assembly and a cross-member beam of a battery cell stack of a traction battery pack.

FIG. 9 illustrates an interface between a thermal barrier assembly and an upper enclosure structure of a traction battery pack.

FIG. 10 illustrates an interface between a thermal barrier assembly and a lower enclosure structure of a traction battery pack.

FIG. 11 illustrates an interface between multiple lower enclosure structures of a traction battery pack.

FIG. 12 illustrates an interface between a thermal barrier assembly and a bus bar of a battery cell stack of a traction battery pack.

### DETAILED DESCRIPTION

This disclosure details thermal barrier assemblies for use within traction battery packs. An exemplary thermal barrier assembly may include features for establishing a sealed interface relative to one or more adjacent structures of a traction battery pack. In some implementations, the thermal barrier assembly may provide features for interfacing with cell stack cross-members beams, upper enclosure structures, lower enclosure structures, etc. The sealed interfaces substantially prevent thermal energy from moving from compartment-to-compartment/cell packet-to-cell packet during a battery thermal event. These and other features are discussed in greater detail in the following paragraphs of this detailed description.

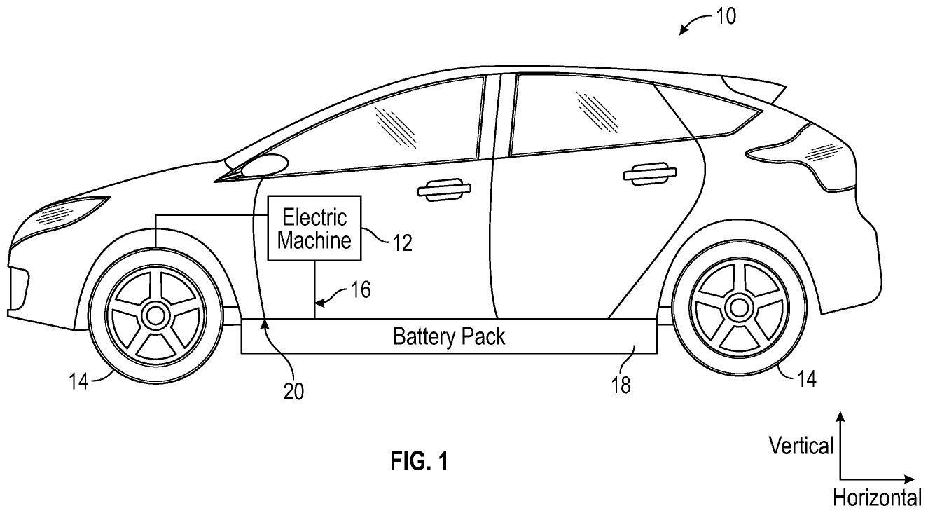

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

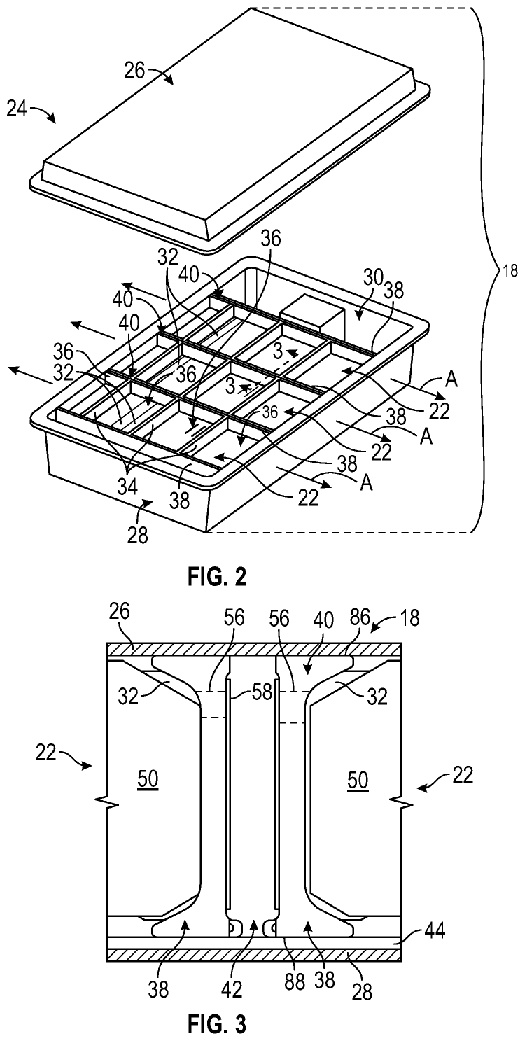

FIGS. 2 and 3 further illustrates details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked side-by-side relative to one another along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure.

One or more thermal barrier assemblies 34 may be arranged along the respective cell stack axis A of each cell stack 22. The thermal barrier assemblies 34 may compartmentalize each cell stack 22 into two or more groupings or compartments 36 of battery cells 32. Each compartment 36 may hold one or more of the battery cells 32 within one of the cell stacks 22. In an embodiment, the battery cells 32 of each cell stack 22 are held within one of four compartments 36. However, other configurations, including configurations that utilize a greater or fewer number of compartments 36, could be used within the scope of this disclosure.

The battery cells 32 of each cell stack 22 may be arranged between a pair of cross-member beams 38. The cross-member beams 38 may be configured to hold the battery cells 32 and at least partially delineate the cell stacks 22.

As further discussed below, the cross-member beams 38 may be adhesively secured to the enclosure cover 26 and to either the enclosure tray 28 or a heat exchanger plate 44 positioned between the enclosure tray 28 and one or more cell stacks 22. The adhesive can seal these interfaces to inhibit battery cell vent byproducts escaping through these areas.

Immediately adjacent-cross member beams 38 may established a cross-member assembly 40 disposed between adjacent cell stacks 22 of the traction battery pack 18. The cross-member assemblies 40 may be configured to transfer a load applied to a side of the electrified vehicle 10, for example. Each cross-member beam 38 of the cross-member assemblies 40 may be a structural beam that can help accommodate tension loads from battery cell 32 expansion and compression loads. The cross-member assemblies 40 are therefore configured to increase the structural integrity of the traction battery pack 18.

The cross-member assembles 40 may also establish a battery pack venting system for communicating battery cell vent byproducts from the traction battery pack 18 during a battery thermal event. For example, the cross-member assemblies 40 may establish passageways 42 (best shown in FIG. 3) that communicate the battery cell vent byproducts from the cell stacks 22 toward a position where the battery cell vent byproducts can be expelled from the traction battery pack 18.

In the exemplary embodiment illustrated in FIG. 3, first and second adjacent cross-member beams 38 may establish a first side and a second side, respectively, of the passageway 42 of the cross-member assembly 40. Further, a vertically upper side of the passageway 42 may be established by the enclosure cover 26, and a vertically lower side of the passageway 42 may be established by a heat exchanger plate 44 positioned against the enclosure tray 28. In another embodiment, the heat exchanger plate 44 may be omitted and the vertically lower side of the passageway 42 may be established by the enclosure tray 28. Vertical and horizontal, for purposes of this disclosure, are with reference to ground and a general orientation of traction battery pack 18 when installed within the electrified vehicle 10 of FIG. 1.

In an embodiment, the cell stacks 22, the cross-member assemblies 40, and the respective passageways 42 extend longitudinally in a cross-vehicle direction. However, other configurations are further contemplated within the scope of this disclosure.

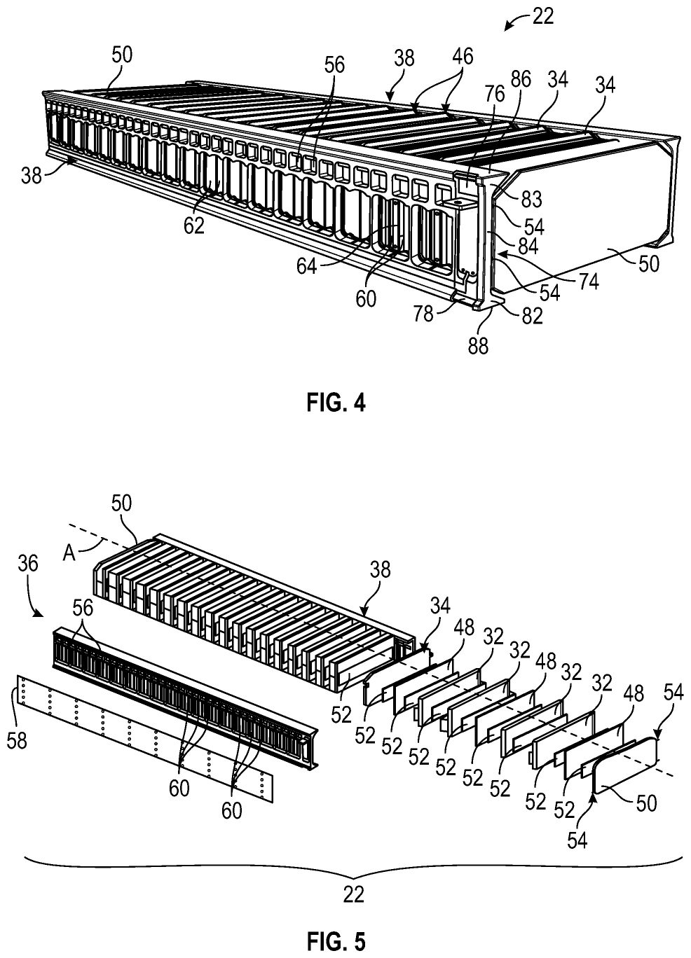

FIGS. 4 and 5, with continued reference to FIGS. 2 and 3, illustrate an exemplary design of a cell stack 22 of the traction battery pack 18. Additional cell stacks 22 of the traction battery pack 18 could include an identical design to the cell stack 22 shown in FIGS. 4-5, or a similar design as its electrical connections with neighboring cell stacks can vary in order to complete a necessary electrical circuit.

The cell stack 22 may include a plurality of cell packets 46 stacked horizontally between a pair of cross-member beams 38 and longitudinally (e.g., side-by-side along the cell stack axis A) between a pair of compression plates 50. The total number of cell packets 46 provided within the cell stack 22 may vary and is therefore not intended to limit this disclosure.

Each compression plate 50 may be made of a plastic material. The compression plates 50 may be configured to accommodate and maintain compression of the cell stack 22 along the cell stack axis A. The compression plates 50 may be attached to the cross-member beams 38. In an embodiment, the compression plates 50 include tabs 54 that are received by the cross-member beams 38.

Each cell packet 46 of the cell stack 22 may include a combination of battery cells 32, one or more thermal barrier assemblies 34, and one or more cell expansion pads 48 that are stacked together along the cell stack axis A. An exemplary stacking configuration of each cell packet 46 may include the following arrangement of subcomponents: battery cell 32—battery cell 32—cell expansion pad 48—thermal barrier assembly 34—cell expansion pad 48—battery cell 32—battery cell 32—cell expansion pad 48. However, the cell packets 46 could embody various other stacking arrangements/configurations within the scope of this disclosure.

The various subcomponents of each cell packet 46 may be secured together using an adhesive, such as strips of two-sided adhesive tape 52, for example. The strips of the two-sided adhesive tape 52 may be interspersed between each adjacent pair of subcomponents of the cell packet 46.

The thermal barrier assemblies 34 may each include a single-piece structure or a multi-layered sandwich structure that is configured to slow or even prevent thermal propagation from cell packet-to-cell packet across the cell stack 22. In an embodiment, the thermal barrier assemblies 34 may be made of a metallic material, such as stainless steel or aluminum, or a thermoplastic material, for example. In another embodiment, the thermal barrier assemblies 34 include an insulating material(s), such as aerogel materials or foam materials. However, other material or combinations of materials could with utilized to provide the thermal barrier assemblies 34 with insulative properties within the scope of this disclosure.

The cell expansion pads 48 may include a compliant material(s) for accommodating battery cell swelling. The compliant material may include polyurethane foam or silicone foam, for example. However, other materials or combinations of materials could be utilized to provide the cell expansion pads 48 with compliant properties within the scope of this disclosure.

Each cross-member beam 38 may include a beam body 74 and one or more reinforcement sections. In the illustrated embodiment, the cross-member beam 38 includes an upper or first reinforcement section 76 and a lower or second reinforcement section 78. However, other configurations are also contemplated within the scope of this disclosure.

The beam body 74 may be a unitary structure that includes an upper portion 83, a lower portion 82, and a mid-portion 84 extending between and connecting the upper portion 83 and the lower portion 82. The upper portion 83 may establish an upper plateau 86 of the cross-member beam 38, and the lower portion 82 may establish a lower base 88 of the cross-member beam 38. When positioned within the enclosure assembly 24 of the traction battery pack 18 in the manner shown in FIG. 3, the upper plateau 86 may interface with the enclosure cover 26, and the lower base 88 may interface with the heat exchanger plate 44 or the enclosure tray 28.

The beam body 74 of each cross-member beam 38 may be made of any suitable thermoplastic material. In an embodiment, the beam body 74 is overmolded about each of the first reinforcement section 76 and the second reinforcement section 78. The first reinforcement section 76 may therefore extend inside the upper portion 83 of the beam body 74, and the second reinforcement section 78 may extend inside the lower portion 82 of the beam body 74. The first and second first reinforcement sections 76, 78 may therefore be positioned to structurally reinforce select portions (e.g., stress areas) of the beam body 74.

In an embodiment, the beam body 74, the first reinforcement section 76, and the second reinforcement section 78 each include substantially equivalent lengths. In other implementations, the length of the beam body 74 may be greater than the respective lengths of the first and second first reinforcement sections 76, 78.

In an embodiment, the first and second first reinforcement sections 76, 78 are pultrusions, which implicates structure to these beam-like sections. A person of ordinary skill in the art having the benefit of this disclosure would understand how to structurally distinguish a pultruded beam structure from another type of structure, such as an extruded beam, for example.

The first and second first reinforcement sections 76, 78 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the first and second first reinforcement sections 76, 78. The first and second first reinforcement sections 76, 78 may then be overmolded by the beam body 74 to provide a desired cross-section of the cross-member beam 38. The beam body 74 may be made of any suitable thermoplastic material.

Each cross-member beam 38 of the cell stack 22 may include a plurality of vent openings 56 for communicating battery cell vent byproducts through the beams and into one of the passageways 42 (note that the passageway 42 is best shown in FIG. 3). The vent openings 56 thus provide a path for battery cell vent byproducts to move through the cross-member beams 38 and into the passageways 42 as required during a venting event.

The vent openings 56 may be formed through the beam body 74 of the cross-member beam 38. In an embodiment, the vent openings 56 are formed through the mid-portion 84 of the beam body 74.

When the battery cells 32 of the cell stack 22 are not venting, the vent openings 56 may be covered by a sectioned membrane 58. A pressure differential increase associated with one or more of the battery cells 32 venting can rupture a local section of the sectioned membrane 58, thereby allowing the battery cell vent byproducts to pass through the vent openings 56 for a single cell packet 46 experiencing a thermal event into the passageway 42. The local sections of the sectioned membrane 58 may locally break away when the single cell packet 46 experiences the thermal event to release the battery cell vent byproducts into the passageway 42. The battery cell vent byproducts may exit on both sides of the cell stack 22 from one cell packet 46.

Each cross-member beam 38 may additionally include a plurality of cell tab openings 60 arranged vertically below the vent openings 56. The cell tab openings 60 may be formed through the beam body 74. In an embodiment, the cell tab openings 60 are formed through the mid-portion 84 of the beam body 74.

Each cell tab opening 60 may be configured to accommodate a cell tab terminal 62 of the battery cells 32. The cell tab terminals 62 extend from a battery cell housing. An aluminum film may provide the battery cell housing, for example.

In an embodiment, each cell tab opening 60 may accommodate one cell tab terminal 62. In another embodiment, each cell tab opening 60 may be sized to receive cell tab terminals 62 from multiple adjacent battery cells 32. Battery vent byproducts may at least partially vent through each cell tab opening 60 in addition to the vent openings 56 during thermal events.

At least a portion of adjacent cell tab openings 60 may be separated by a backing tab 64 of the cross-member beam 38. The cross-member beams 38 may each include multiple backing tabs 64. Each backing tab 64 may provide a suitable backing surface for joining (e.g., welding) the cell tab terminals 62 together in order to electrically connect the battery cells 32 of the cell packet 46. To electrically connect the cell tab terminals 62, the cell tab terminals 62 may be extended through their respective cell tab openings 60 and then folded over the backing tab 64 such that the cell tab terminals 62 overlap one another. When folded, the cell tab terminals 62 are located on an opposite side of the cross-member beam 38 from the housings of the battery cells 32. The overlapped cell tab terminals 62 may then be welded together, such as via a laser welding process, for example, for electrically connecting the cell tab terminals 62.

The backing tab 64 may additionally provide a sense lead that can be used to collect data. For example, a voltage of the cell tab terminals 62 of the battery cells 32 may be monitored and collected by the backing tab 64.

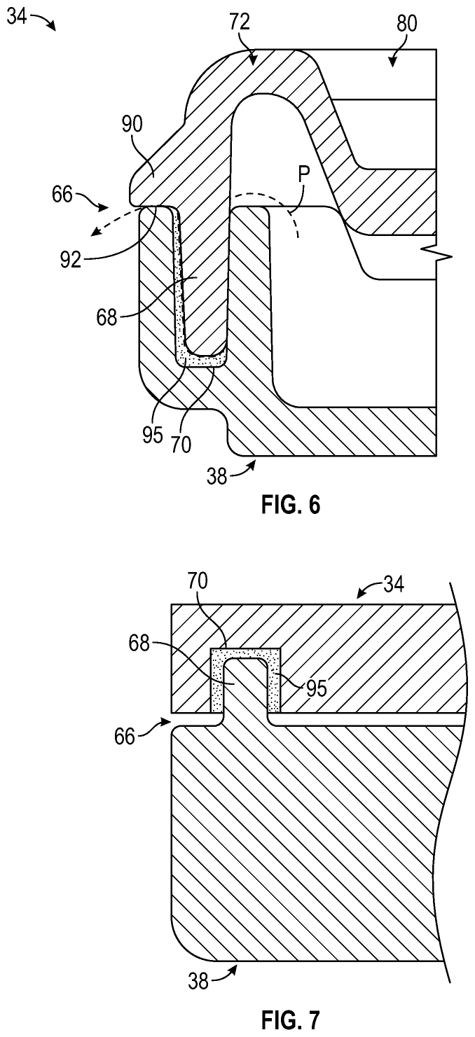

FIG. 6, with continued reference to FIGS. 2-5, illustrates a sealed interface between a thermal barrier assembly 34 and a cross-member beam 38 of one the cell stacks 22 of the traction battery pack 18. The thermal barrier assembly 34 may interface with an additional cross-member beam located on an opposite lateral side of the cell stack 22 in a similar manner as that shown in FIG. 6.

The thermal barrier assembly 34 may be connected to the cross-member beam 38 via a tongue-and-groove connection 66 provided at a lateral side of the thermal barrier assembly 34. In an embodiment, a male portion 68 (e.g., a protrusion) of the tongue-and-groove connection 66 is provided by the thermal barrier assembly 34, and a female portion 70 (e.g., a channel) of the tongue-and-groove connection 66 is provided by the cross-member beam 38. In another embodiment, the male portion 68 of the tongue-and-groove connection 66 is provided by the cross-member beam 38, and the female portion 70 of the tongue-and-groove connection 66 is provided by the thermal barrier assembly 34 (see FIG. 7).

In an embodiment, the male portion 68 (or alternatively the female portion 70) is established by a fin 72 of the thermal barrier assembly 34. The fin 72 may be made of a metallic or polymer composite material. In an embodiment, the fin 72 is made of stainless steel. In another embodiment, the fin 72 is made of aluminum. However, other materials could be utilized to construct the fin 72 within the scope of this disclosure.

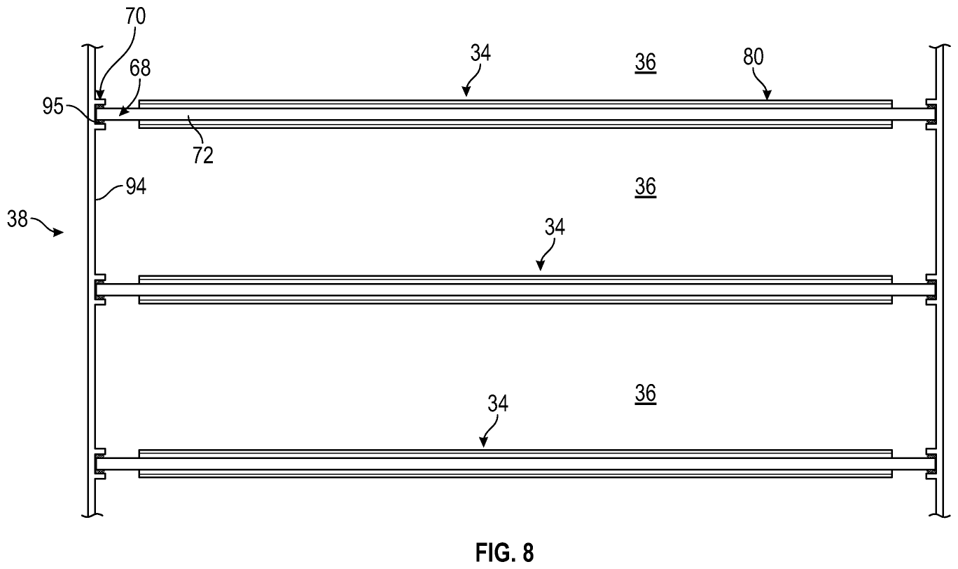

The fin 72 may be integrally formed with a protective housing 80 of the thermal barrier assembly 34. Portions of the fin 72 may extend inside the protective housing 80 (see, for example, the embodiment of FIG. 8). A stop 90 of the fin 72 may limit an insertion distance of the male portion 68 into the female portion 70 of the tongue-and-groove connection 66.

In an embodiment, the female portion 70 (or alternatively the male portion 68) is provided within the mid-portion 84 of the beam body 74 of the cross-member beam 38. The female portion 70 may be formed either in an end-facing surface 92 (e.g. the surface that faces toward one of the compression plates 50 of the cell stack 22) of the cross-member beam 38 (see FIG. 6) or in an inside-facing surface 94 (e.g. the surface that faces toward the opposite cross-member beam 38) of the cross-member beam 38 (see FIG. 8).

An adhesive 95 may be utilized to secure the male portion 68 within the female portion 70. The adhesive 95 may be an epoxy based adhesive or a urethane based adhesive, for example.

The tongue-and-groove connection 66 may establish a tortuous gas path P between thermal barrier assembly 34 and the cross-member beam 38. The tortuous gas path P substantially prevents thermal energy (e.g., from battery vent byproducts) from matriculating from one compartment 36 to another at the sealed interface between the thermal barrier assembly 34 and the cross-member beam 38 during a battery thermal event.

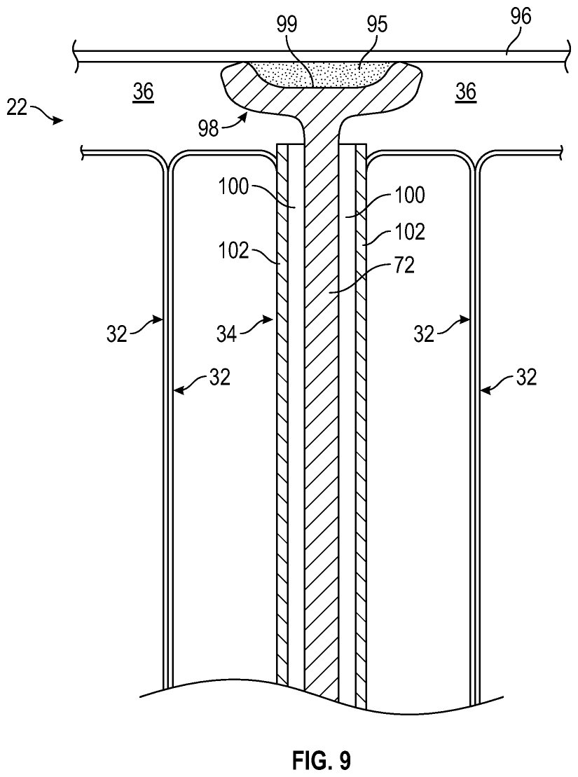

FIG. 9, with continued reference to FIGS. 2-8, illustrates a sealed interface between the thermal barrier assembly 34 and an upper enclosure structure 96 of the traction battery pack 18. In an embodiment, the upper enclosure structure 96 is part of the enclosure cover 26 of the enclosure assembly 24. However, in other implementations, the thermal barrier assembly 34 may interface directly with an intermediate structure (e.g., a heat exchanger plate) that is positioned between the thermal barrier assembly 34 and the enclosure cover 26.

The thermal barrier assembly 34 may include an upper interfacing structure 98 that is configured to interface with the upper enclosure structure 96 of the traction battery pack 18. In an embodiment, the upper interfacing structure 98 is part of a fin 72 of the thermal barrier assembly 34. The fin 72 may be a metallic or polymer composite structure that is flanked by aerogel layers 100 and foam layers 102 as part of a multi-layer sandwich structure of the thermal barrier assembly 34. However, other configurations of the thermal barrier assembly 34 are possible within the scope of this disclosure.

The upper interfacing structure 98 may include a basin 99 for receiving and holding an adhesive 95. The adhesive 95 may be utilized to secure the thermal barrier assembly 34 to the upper enclosure structure 96. The adhesive 95 may be an epoxy based adhesive or a urethane based adhesive, for example. Once the upper interfacing structure 98 is secured relative to the upper enclosure structure 96, the thermal barrier assembly 34 substantially prevents thermal energy from moving from one compartment 36 to another at the sealed interface between the thermal barrier assembly 34 and the upper enclosure structure 96 during a battery thermal event.

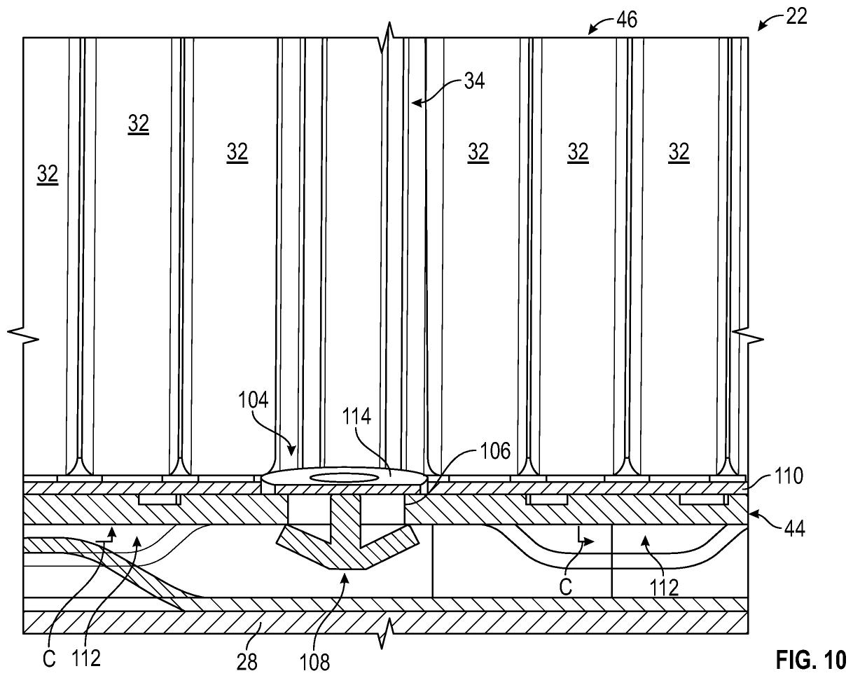

FIG. 10, with continued reference to FIGS. 2-9, illustrates an interface between the thermal barrier assembly 34 and a heat exchanger plate 44 of the traction battery pack 18. In an embodiment, the heat exchange plate 44 is positioned between the cell stack 22 and the enclosure tray 28 and is therefore considered to be a lower enclosure structure of the traction battery pack 18.

The thermal barrier assembly 34 may include a lower interfacing structure 104 that is configured to interface with the heat exchanger plate 44 of the traction battery pack 18. The lower interfacing structure 104 may be disposed on an opposite end of the thermal barrier assembly 34 from the upper interfacing structure 98 and can help locate the thermal barrier assembly 34 relative to the heat exchanger plate 44 during assembly. The lower interfacing structure 104 may further be configured for sealing the interface and limiting compression between the thermal barrier assembly 34 and the heat exchanger plate 44.

The heat exchanger plate 44 may include one or more slots 106 sized to receive the lower interfacing structure 104. Each slot 106 may establish a thermal break between neighboring battery cells 32 of the cell stack 22 within which the thermal barrier assembly 34 is disposed. The lower interfacing structure 104 may be positioned such that a projecting seal 108 of the lower interfacing structure 104 is at least partially received within the slot 106. Therefore, in addition to acting as a locating feature for locating the thermal barrier assembly 34 relative to the heat exchanger plate 44, the lower interfacing structure 104 may at least partially fill the slot 106 in order to seal the interface between the thermal barrier assembly 34 and the heat exchanger plate 44 and thus prevent thermal energy from moving from one cell packet 46 to another at the interface between the thermal barrier assembly 34 and the heat exchanger plate 44 during a battery thermal event.

A thermal interface material 110 may be disposed between the battery cells 32 of the cell stack 22 and the heat exchanger plate 44. In an embodiment, downwardly facing bottom surfaces of the battery cells 32 are in direct contact with the thermal interface material 110. However, other configurations are contemplated within the scope of this disclosure. The thermal interface material 110 may be configured to fixedly secure the battery cells 32 in place relative to the heat exchanger plate 44.

The thermal interface material 110 may be further configured to maintain thermal contact between the battery cells 32 and the heat exchanger plate 44, thereby facilitating thermal conductivity between these neighboring components during heat transfer events. Heat conducted from the battery cells 32 to the heat exchanger plate 44 may then be carried away from the battery cells 32 by a coolant C that is circulated within an internal coolant circuit 112 of the heat exchanger plate 44.

The projecting seal 108 may extend outwardly (e.g., downwardly toward the heat exchanger plate 44) of a base portion 114 of the lower interfacing structure 104. The base portion 114 may be made of a flexible material (e.g., rubber), and the projecting seal 108 may be made of a more rigid material (e.g., polypropylene) as compared to the base portion 114. The projecting seal 108 may extend through the thermal interface material 110 and be accommodated within the slot 106, thereby substantially preventing the lower interfacing structure 104 from subsequently backing out of the slot 106.

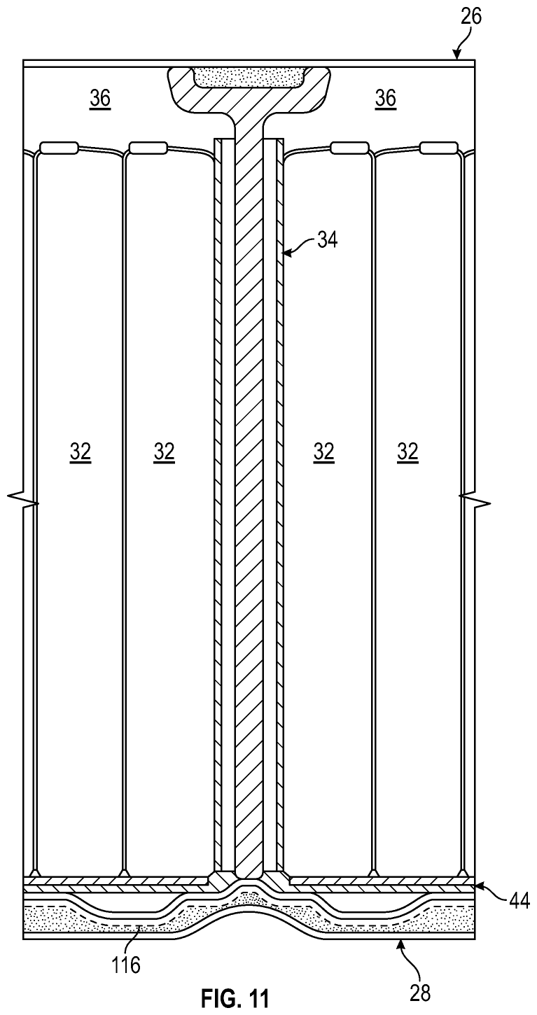

The slot 106 may additionally or alternatively be sealed by an adhesive. For example, as shown in FIG. 11, an expandable adhesive 116 may be disposed between the enclosure tray 28 and the heat exchanger plate 44 for sealing the slot 106.

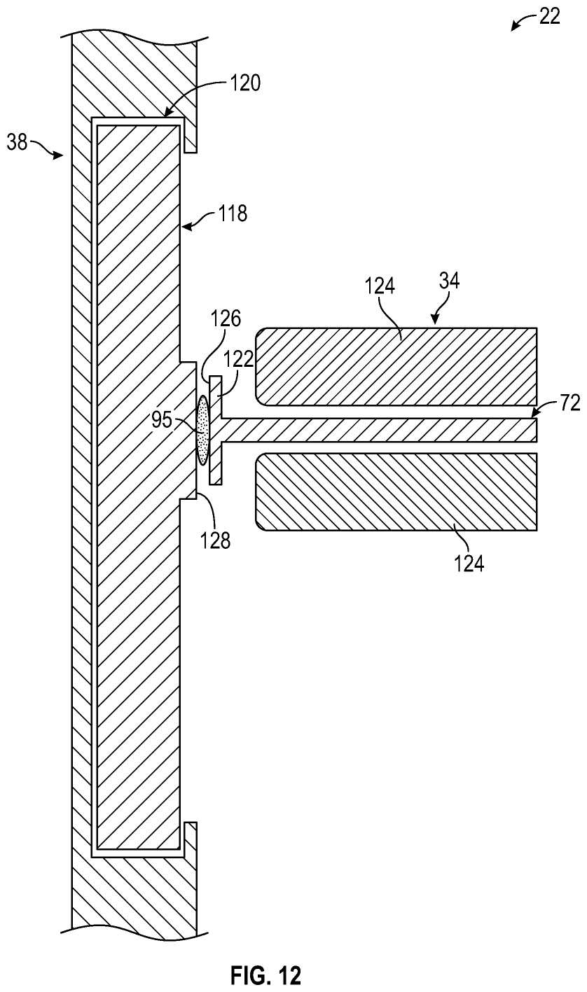

FIG. 12, with continued reference to FIGS. 2-11, illustrates a sealed interface between a thermal barrier assembly 34 and a bus bar 118 of one the cell stacks 22 of the traction battery pack 18. The bus bar 118 may be accommodated within a bus bar frame 120 of one of the cross-member beams 38 of the cell stack 22.

The thermal barrier assembly 34 may include a side interfacing structure 122 provided at a lateral side of the thermal barrier assembly 34. The side interfacing structure 122 may be configured to interface with the bus bar 118. In an embodiment, the side interfacing structure 122 is part of a fin 72 of the thermal barrier assembly 34. The fin 72 may be a metallic or polymer composite structure that is flanked by aerogel/foam layers 124 as part of a multi-layer sandwich structure of the thermal barrier assembly 34. However, other configurations of the thermal barrier assembly 34 are possible within the scope of this disclosure. In an embodiment, the fin 72 may float between the aerogel/foam layers 124 for accommodating tolerance stack-ups.

The side interfacing structure 122 may include a flat surface 126 that may be positioned relative to a flat section 128 of the bus bar 118. An adhesive 95 may be applied between the flat section 128 of the bus bar 118 and the flat surface 126 of the thermal barrier assembly 34 for securing the thermal barrier assembly 34 to the bus bar 118. The adhesive 95 may be an epoxy based adhesive or a urethane based adhesive, for example. Once secured in place, the side interfacing structure 122 may substantially prevent thermal energy from moving from one compartment 36 to another at the interface between the thermal barrier assembly 34 and the bus bar 118 during a battery thermal event.

Notably, as would be appreciated by a person of ordinary skill in the art having the benefit of this disclosure, the thermal barrier assemblies 34 of the traction battery pack 18 could be equipped with any combination of the features described above and shown in FIGS. 6-12 in order to provide a sealed interface about an entire perimeter of the thermal barrier assembly 34.

The thermal barrier assemblies of this disclosure are capable of providing a sealed interface relative to various surrounding structures within a traction batter pack. For example, the thermal barrier assemblies may provide features for interfacing with cell stack cross-members beams, upper enclosure structures, lower enclosure structures, etc. The sealed interfaces substantially prevent thermal energy from cascading across a cell stack during a battery thermal event.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack comprising:
a first cross-member beam;
a battery cell supported by the first cross-member beam; and
a thermal barrier assembly connected to the first cross-member beam by a tongue-and-groove connection.

2. The traction battery pack as recited in claim 1, wherein the battery cell is supported between the first cross-member beam and a second cross-member beam.

3. The traction battery pack as recited in claim 2, comprising a third cross-member beam adjacent to the first cross-member beam, wherein the first cross-member beam and the third cross-member beam establish a cross-member assembly arranged between the cell stack and a second cell stack of the traction battery pack.

4. The traction battery pack as recited in claim 3, comprising a venting passageway disposed between the first cross-member beam and the third cross-member beam.

5. The traction battery pack as recited in claim 1, wherein the thermal barrier assembly provides a male portion of the tongue-and-groove connection, and the first cross-member beam provides a female portion of the tongue-and-groove connection.

6. The traction battery pack as recited in claim 5, wherein the male portion includes a protrusion that is part of a fin of the thermal barrier assembly.

7. The traction battery pack as recited in claim 5, wherein the female portion includes a groove formed at an end-facing surface of the first cross-member beam, wherein the end-facing surface faces in a direction toward a compression plate of the cell stack.

8. The traction battery pack as recited in claim 5, wherein the female portion includes a groove formed at an inside-facing surface of the first cross-member beam, wherein the inside-facing surface faces in a direction toward a second cross-member beam of the cell stack.

9. The traction battery pack as recited in claim 5, comprising an adhesive disposed between the male portion and the female portion.

10. The traction battery pack as recited in claim 1, wherein the thermal barrier assembly includes an upper interfacing structure configured to interface with an upper enclosure structure of the traction battery pack.

11. The traction battery pack as recited in claim 10, wherein the upper interfacing structure includes a basin configured to receive an adhesive.

12. The traction battery pack as recited in claim 1, wherein the thermal barrier assembly includes a lower interfacing structure configured to interface with a heat exchanger plate of the traction battery pack.

13. The traction battery pack as recited in claim 12, wherein the lower interfacing structure includes a seal received within a slot of the heat exchanger plate.

14. The traction battery pack as recited in claim 12, comprising an expandable adhesive disposed between the heat exchanger plate and an enclosure tray of the traction battery pack.

15. The traction battery pack as recited in claim 1, wherein the thermal barrier assembly includes a side interfacing structure configured to interface with a bus bar of the cell stack.

16. A traction battery pack, comprising:
an enclosure assembly establishing an interior area;
a cell stack housed within the interior area and including a thermal barrier assembly;
a heat exchanger plate arranged between the cell stack and an enclosure tray of the enclosure assembly; and
the thermal barrier assembly configured to establish a first sealed interface relative to an upper enclosure structure, a second sealed interface relative to the heat exchanger plate, and a third sealed interface relative to a first cross-member beam of the cell stack.

17. The traction battery pack as recited in claim 16, wherein the first sealed interface is established by an upper interfacing structure of the thermal barrier assembly and the upper enclosure structure, and further wherein an adhesive is disposed between the upper interfacing structure and the upper enclosure structure.

18. The traction battery pack as recited in claim 16, wherein the second sealed interface is established by a lower interfacing structure of the thermal barrier assembly and the heat exchanger plate, and further wherein the lower interfacing structure includes a seal received within a slot of the heat exchanger plate.

19. The traction battery pack as recited in claim 16, wherein the third sealed interface is established by a tongue-and-groove connection provided by the thermal barrier assembly and the first cross-member beam.

20. The traction battery pack as recited in claim 16, wherein the thermal barrier assembly is configured to establish a fourth sealed interface relative to a bus bar that is held within the first cross-member beam.
